(19) United States
(12) Patent Application Publication
(10) Pub. No.: US 2007/0070094 A1
(43) Pub. Date: Mar. 29, 2007

(54) Graphical user interface for managing native display resolution from a distance

(76) Inventors: Ruth Ann Lim, Santa Clara, CA (US); Karl R. Hassur, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/240,442

(22) Filed: Sep. 29, 2005

(51) Int. Cl. G09G 5/02

(52) U.S. Cl. 345/698

(57) ABSTRACT

An exemplary method for managing display resolution of a display from a distance is provided including: selecting a display resolution within a graphical user interface environment, where the graphical user interface environment is configured to be readable at a distance more than approximately two meters; selecting a native display setting in response to selecting the display resolution; and applying the native display setting to the display. In some embodiments, methods further include displaying a revert selection; and optionally selecting the revert selection such that the applying the native display setting is cancelled. In some embodiment selecting the native display setting includes: accessing a native display setting via a native API; requesting the native display setting via the native API corresponding to the selecting the display resolution; and receiving the native display setting.

### CROSS REFERENCE TO RELATED APPLICATIONS

The present invention is related to the following applications, all of which are incorporated herein by reference:

Commonly assigned application entitled “METHODS AND SYSTEMS FOR HANDLING HIDDEN DIALOGS IN A MEDIA CENTERED GRAPHICAL USER ENVIRONMENT,” filed on even date herewith by the same inventors herein (Attorney Docket Number 200407710-1).

### BACKGROUND

Media display systems have become increasingly sophisticated as technology advances have made more media streams available to users. From over the air broadcasts to Internet streaming video, media display systems are now enabled to manage and process a variety of complex media streams. In particular, display resolution may vary widely between display formats. For example, a 640×480 resolution may be utilized for accessing menu options of an underlying operating system while a 1920×1080 resolution may be utilized for displaying multimedia entertainment content. In switching between these widely variant resolutions, some media display systems may require users to access hidden display control settings which may or may not be displayed in an acceptable format.

For example, FIG. 1 is an illustrative flowchart of a prior art system of managing display resolutions. In the example shown, the method occurs within a WINDOWS™ Media Center environment. Thus, a user, attempting to modify resolution in a media display system may, at a step 102 exit or minimize WINDOWS™ Media Center environment. This step may, in some examples, be required to access otherwise hidden control settings. At a next step 104, the method opens display properties. It may be appreciated that the selections described herein may be accomplished via mouse, keyboard, or some other I/O device. It may also be appreciated that hidden control settings, in some embodiments, are displayed in a small font, not well-suited to viewing at a distance or on low resolution monitors. At a next step 106, the method selects a display settings tab. In general, display settings may be selected in accordance with user preferences. The method then determines whether 640×480 resolution is available. In XP editions of WINDOWS™ 640×480 is not a generally supported resolution. Thus, if 640×480 resolution is desired, then the method continues to a step 110 to select advanced properties. If 640×480 resolution is not desired, then the method selects a desired resolution at a step 118.

At a next step 112, adapter tab may be selected. From the adapter tab, list all modes may be selected at a step 114. In this manner, 640×480 resolution may be selected. It may be appreciated that most common television displays have a resolution of 640×480. Therefore selection of 640×480 resolution may, in some examples, be required. A revert dialog box may be displayed and optionally selected at a step 120. Revert permits a user to cancel a selected resolution. At a next step 122, an apply/exit box may be displayed and selected. The method then returns to WINDOWS™ Media Center environment at a step 124. In this manner, display resolution may be managed under prior art methods.

Turning briefly to FIG. 2, which is an illustrative representation of a prior art display 200. FIG. 2 represents at least one difficulty in displaying unsupported resolutions. Displaying unsupported resolutions may result, in some examples in a dialog having a displayed portion 204 and a hidden portion 208. Thus, a user making a selection on displayed portion 204 would not be able to accept or cancel that selection until hidden portion 208 was sufficiently displayed by scrolling. However, as hidden portion 208 was scrolled on screen, displayed portion 204 would simultaneously be scrolled off screen. Thus, a user may, in some examples, never be able to see all available selections. In this manner, making several selections may become increasingly tedious and time consuming as users scroll between displayed and hidden portions. In addition, a user may not be able to interact with dialog controls (e.g. push buttons or check boxes) while using a “move” function to scroll a dialog box into viewing range.

As such, easily configured display resolutions for media center displays that may be easily read and managed from a distance may be desirable. Therefore, graphical user interfaces for managing native display resolution from a distance are presented.

### SUMMARY

The invention provides a graphical user interface for managing native display resolution from a comfortable viewing distance that may be deployed across a wide range of viewing environments and may enhance a user's viewing experience.

An exemplary method for managing display resolution of a display from a distance is presented including: selecting a display resolution within a graphical user interface environment, where the graphical user interface environment is configured to be readable at a distance more than approximately two meters; selecting a native display setting in response to selecting the display resolution; and applying the native display setting to the display. In some embodiments, methods further include displaying a revert selection; and optionally selecting the revert selection such that the applying the native display setting is cancelled. In some embodiment selecting the native display setting includes: accessing a native display setting via a native API; requesting the native display setting via the native API corresponding to the selecting the display resolution; and receiving the native display setting.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative flowchart of a prior art system of managing display resolutions;

FIG. 2 is an illustrative representation of a prior art display;

FIG. 3 is an illustrative representation of a display in accordance with an embodiment of the present invention;

FIG. 4 is an illustrative flowchart of a method of managing native display resolution at a distance in accordance with an embodiment of the present invention; and

FIG. 5 is an illustrative diagram of a system for managing native display resolution at a distance in accordance with an embodiment of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

FIG. 3 is an illustrative representation of a display 300 in accordance with an embodiment of the present invention. As noted above, in some example prior art solutions, an unsupported display resolution may result in a dialog box having a displayed portion 204 and a hidden portion 208 (see FIG. 2). Embodiments of the present invention contemplate reducing or eliminating hidden portions of any dialog box so that a user may not be burdened with scrolling to display selections as described above. Thus, in the embodiments illustrated, dialog box 304 may be fully displayed. Furthermore, dialog box 304 may, in some embodiments, be enabled by a graphical user interface that is configured to be readable at a distance of more than approximately two meters. Thus, a user may configure display resolution without moving closer to a viewing monitor, or without switching to a different monitor.

FIG. 4 is an illustrative flowchart of a method of managing native display resolution at a distance in accordance with an embodiment of the present invention. At a first step 404, the method exits or minimizes a media center environment. In some examples, exiting an environment is necessary to access native display resolution settings. In other examples, minimizing an environment is necessary to access native display resolution settings. In still other examples, exiting and minimizing an environment is not necessary to access native display resolution settings. At a next step 408, a display settings manager is selected. A display settings manager is a generalized term that describes an application that manages native display resolutions. As may be appreciated, selecting may be accomplished in any manner known in the art without departing from the present invention. In a preferred embodiment, a display settings manager is configured to graphically display the graphical user interface such that the graphical user interface may be readable at a distance of more than approximately two meters. Thus, usability at a distance may be accomplished.

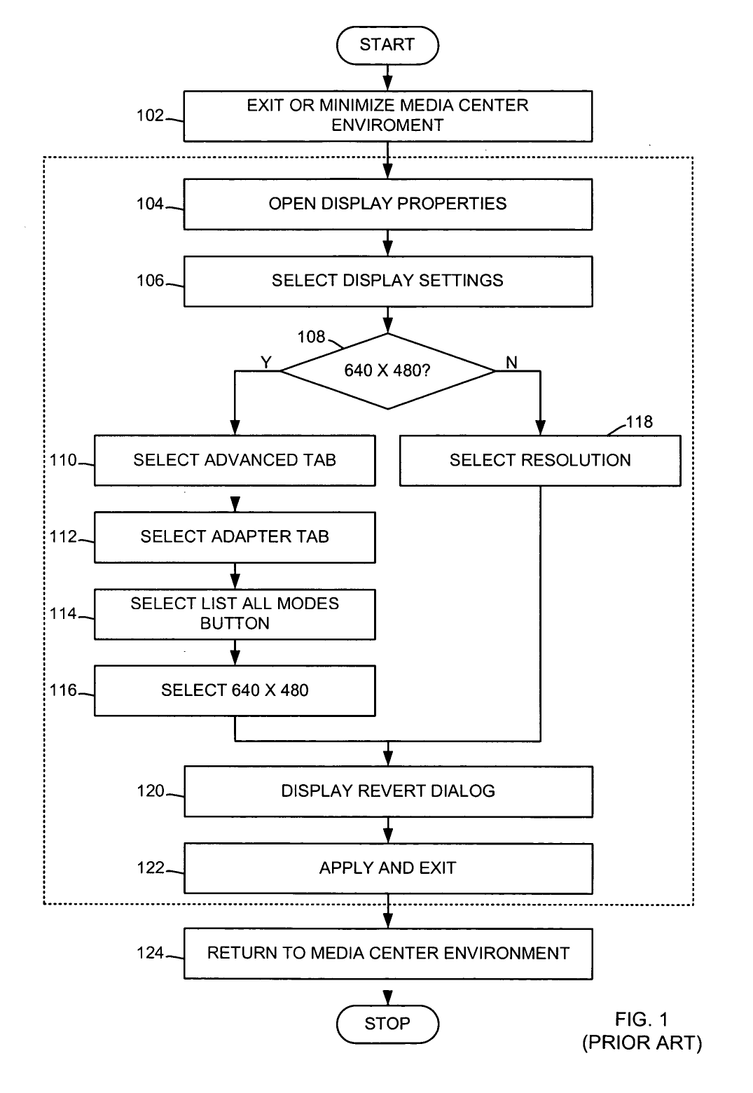

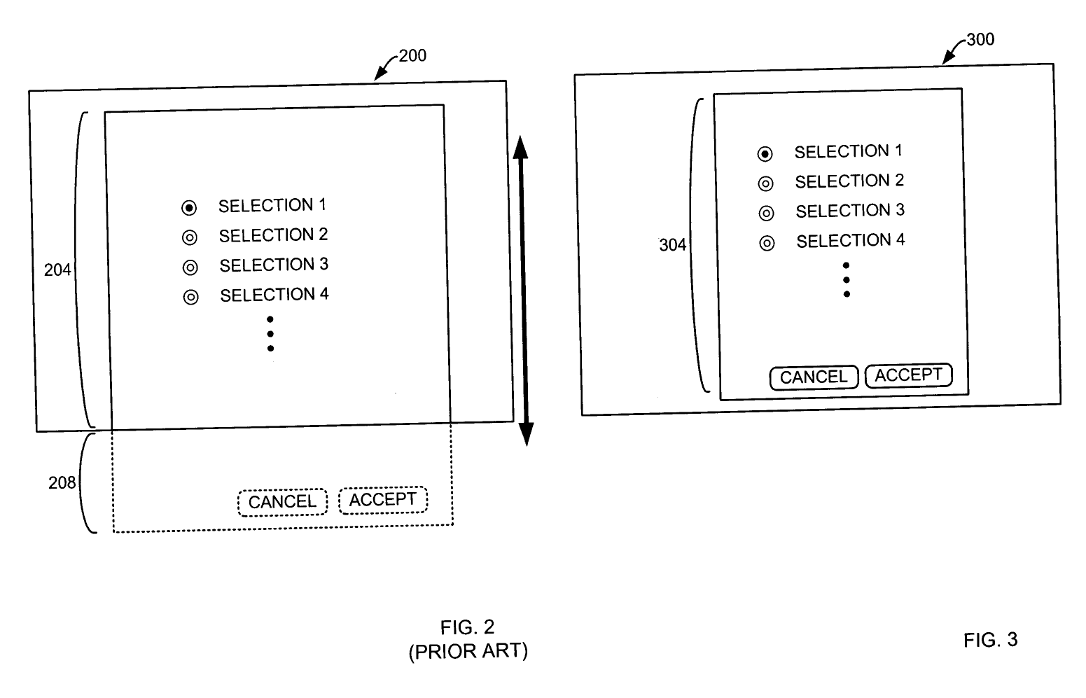

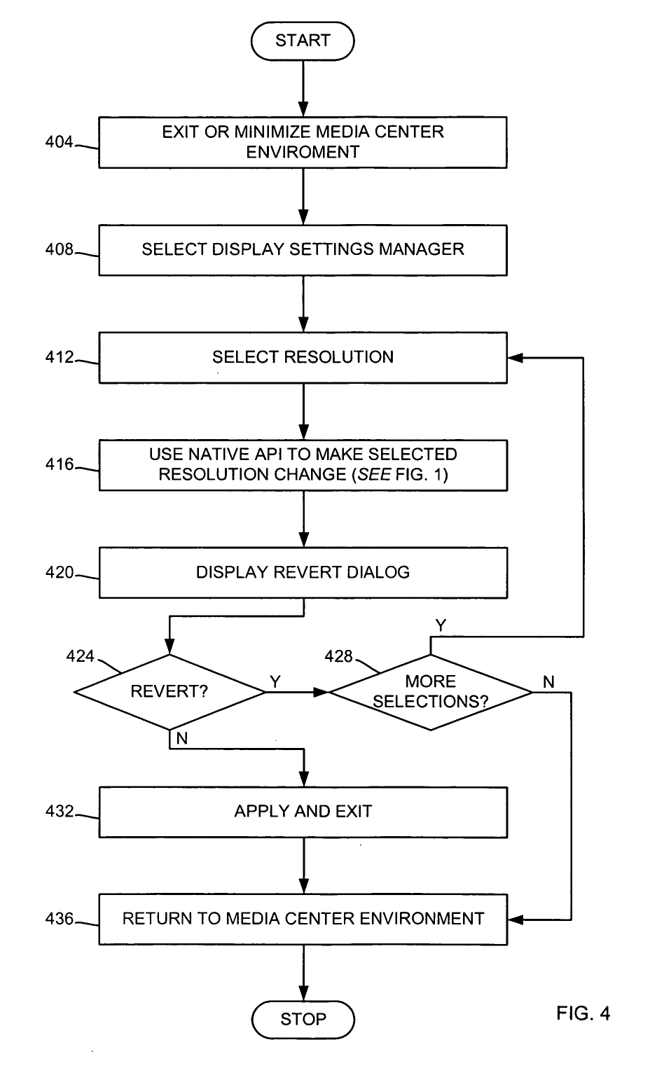

At a next step 412, a resolution may be selected. As noted above, unsupported resolutions generally require a user to navigate several menus and dialog boxes. In examples where a user is not well-versed in display configuration, changing native display resolutions may present an insurmountable hurdle. Thus, a display settings manager may be configured to present all resolutions to a user whether a default operating system user interface shows the settings or not. After a user selects a resolution, the method then accesses a native API to make a selected resolution at a step 416. One method of accessing native display settings is described above for FIG. 1. Thus, the present invention provides an easily navigable user interface to access a more complex native display settings interface. As noted above, the steps described herein may be configured to be accomplished at a distance. It may be appreciated that the present invention may find utility over any operating system that does not provide easy access to native display settings.

Once the native API has been accessed and a native display resolution has been selected and enabled, the method then optionally displays a revert dialog at a step 420. A revert dialog allows a user to revert to previous settings if selected settings are unacceptable or cannot be enabled. If a user reverts at a step 424, the user may then determine whether to apply a new selection at a step 428. If the user decides to make a new selection, the method returns to a step 412. If the user declines to make a new selection, the method returns to media center environment at a step 436 whereupon the method ends. If, at a step 424, the user does not revert, the method continues to apply the selected resolution and exit at a step 432 whereupon returns to media center environment at a step 436 and then ends.

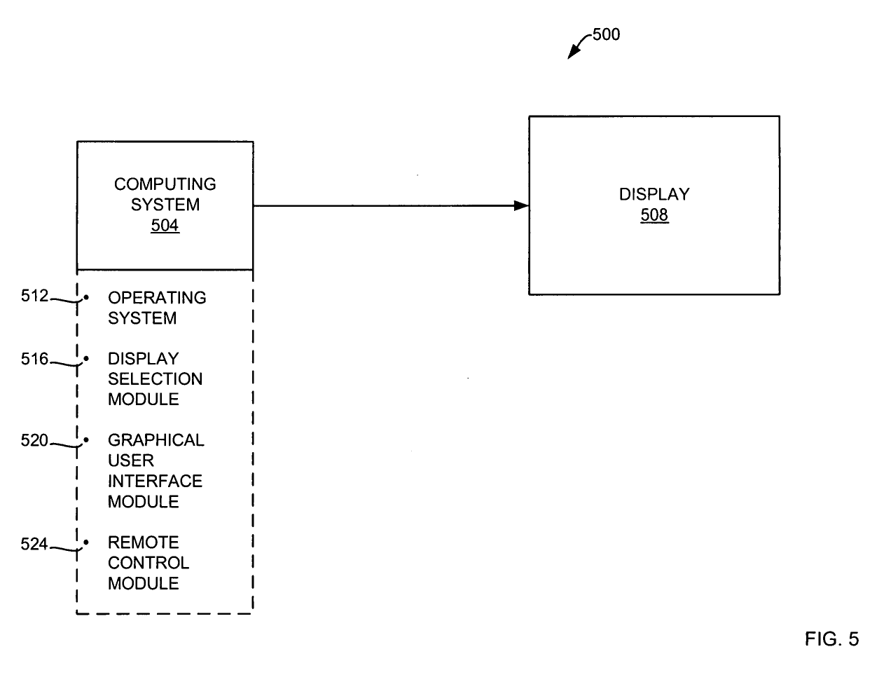

FIG. 5 is an illustrative diagram of a system 500 for managing native display resolution at a distance in accordance with an embodiment of the present invention. In the illustrated embodiment, display 508 may be utilized to display content from computing system 504. As can be appreciated, any number of native display resolution settings may be displayed including, for example, 640×480, 720×480, 800×600, 1024×768, 1280×720, and 1920×1080 depending on user preferences and configuration requirements. Furthermore, resolutions may be interlace or progressive scan depending on hardware and software requirements. Computing system 504 may be enabled for media presentation and include any number of functional modules. For example, operating system 512 may be utilized to control and manage computing system 504. As can be appreciated, any number of operating systems may be utilized without departing from the present invention. Display selection module 516 may be configured for selecting display resolutions that are programmatically controlled by operating system 512. In some embodiments, display selection module 516 may be programmatically configured to access any available native display resolution setting. In other embodiments, display selection module 516 may be programmatically configured to access any available WINDOWS™ native display resolution setting. In some embodiments, generally unsupported display resolution settings may be accessed.

Graphical user interface module 520 may be configured for graphically accessing the display selection module 516. In some embodiments, the graphical user interface module 520 may be configured for use from a distance where the distance is at least two meters. As noted above, configuring a graphical user interface in this manner allows a user to access control settings without moving nearer to a display or without switching to a higher resolution display. Remote control module 524 may be configured for remotely accessing graphical user interface module 520. As can be appreciated, computing systems may be generally accessed by a mouse or keyboard. In some examples, use of a mouse or keyboard may be difficult or impossible. Therefore, remote control module 524 further enables wireless communication with computing system 504 using a remote control I/O device. Any number of wireless devices may be utilized without departing from the present invention.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for managing display resolution of a display from a first distance comprising:
selecting a display resolution within a graphical user interface environment, the graphical user interface environment configured to be readable at a first distance wherein the first distance is more than approximately two meters;
selecting a native display setting in response to the selecting the display resolution; and
applying the native display setting to the display.

2. The method of claim 1 further comprising:
displaying a revert selection; and
optionally selecting the revert selection such that the applying the native display setting is cancelled.

3. The method of claim 1 wherein the selecting the native display setting comprises:
accessing a native display setting via a native API;
requesting the native display setting via the native API corresponding to the selecting the display resolution; and
receiving the native display setting.

4. The method of claim 1 wherein selecting the display resolution is programmatically configured to access any available WINDOWS™ display resolution setting.

5. The method of claim 4 wherein the display resolution setting is selected from the group consisting of: 640×480, 720×480, 800×600, 1024×768, 1280×720, and 1920×1080.

6. The method of claim 1 wherein the graphical user interface is configured to run in a WINDOWS™ Media Center environment.

7. A graphical user interface for managing native display resolution from a first distance comprising:
a first panel for rendering a plurality of native display resolution selections, the first panel configured to be readable at the first distance wherein the first distance is more than approximately two meters;
a second panel for rendering a selected native display resolution, the second panel configured to be readable at the first distance; and
a third panel for rendering an apply and exit selection, the fourth panel configured to be readable at the first distance.

8. The graphical user interface of claim 7 further comprising a fourth panel for rendering a revert selection, the third panel configured to be readable at the first distance.

9. The graphical user interface of claim 7 wherein the third panel further renders a cancel selection.

10. The graphical user interface of claim 7 wherein the graphical user interface is operable by a remote control I/O device.

11. The graphical user interface of claim 7 wherein the plurality of native display resolution selections are programmatically configured to access any available WINDOWS™ display resolution settings.

12. The graphical user interface of claim 7 wherein the graphical user interface is configured to run over a WINDOWS™ Media Center environment.

13. A system for managing display resolutions from a distance comprising:
an operating system for operating a computing system;
a display selection module for selecting native display resolution settings that are programmatically controlled by the operating system;
a graphical user interface module for graphically accessing the display selection module, the graphical user interface module configured for use from a distance wherein the distance is at least two meters; and
a remote control module for remotely accessing the graphical user interface module.

14. The system of claim 13 wherein the operating system is a WINDOWS™ compatible system.

15. The system of claim 13 wherein selecting the display selection module is programmatically configured to access any available native display resolution setting.

16. The system of claim 13 wherein the graphical user interface module is configured to run over a WINDOWS™ Media Center environment.

17. The system of claim 13 wherein the remote control module is configured for wireless operation.
